(19) United States
(12) Patent Application Publication
(10) Pub. No.: US 2004/0264823 A1
(43) Pub. Date: Dec. 30, 2004

(54) Grease lubricated bearing housing

(75) Inventors: Henrik Olsson, Katrineholm (SE); Jorgen Stendahl, Vingaker (SE); Kjell Clasborn, Katrineholm (SE)

Correspondence Address: BURNS DOANE SWECKER & MATHIS L L P, POST OFFICE BOX 1404, ALEXANDRIA, VA, 22313-1404, US

(73) Assignee: Aktiebolaget SKF, Goteborg (SE)

(21) Appl. No.: 10/765,470

(22) Filed: Jan. 28, 2004

(30) Foreign Application Priority Data
Jan. 28, 2003 (SE) 0300199-7

(51) Int. Cl. F16C 19/00

(52) U.S. Cl. 384/474

(57) ABSTRACT

A grease lubricated bearing housing is provided with an opening receiving a shaft and has a housing wall arranged to form a seat for the outer race ring of a bearing, with a space on each axial side of the seat that being limited by an axially extending wall portion and a radial gable wall. The wall of the housing is provided with a through bore for receiving a grease nipple, with the bore opening into the interior of the housing in at least one of the two spaces axially outside the bearing seat. The interior of the housing wall is provided with a material conglomeration positioned relative to the through bore so that the material conglomeration forms a shield urging grease introduced through the through bore to move primarily towards the bearing seat while also preventing grease from primarily filling out the space into which the through bore opens.

This application is based on and claims priority under 35 U.S.C. § 119 with respect to Swedish Application No. 0300199-7 filed on Jan. 28, 2003, the entire content of which is incorporated herein by reference.

### FIELD OF THE INVENTION

The present invention generally relates to bearings. More particularly, the present invention pertains to a grease lubricated bearing housing.

### BACKGROUND OF THE INVENTION

Rolling bearings positioned in bearing housings require lubrication for reduced friction and cooling purposes. In many cases it is sufficient to provide the bearing housing with a quantity of lubricant in the form of oil or grease, which will provide adequate lubrication during the life span of the bearing assembly, or at least during periods between routine inspections.

Certain operating conditions, such as high rotational speeds, high temperatures or heavy loads necessitate more frequent relubrication. For this purpose, the wall of bearing housings has been provided with drilled through-holes in which have been positioned grease nipples. Through these grease nipples, relubrication can be carried out by introducing grease through use of an appropriate grease gun.

Commonly, the bore in the bearing housing wall has been positioned outside the bearing seat in the bearing housing, such as illustrated in FIG. 1 which shows such a prior art arrangement. In this arrangement, the bearing housing is schematically shown in cross-section. Referring to FIG. 1, a bearing 2 is mounted with its inner bearing ring on a shaft 3 extending through the bearing housing, and its outer bearing ring inserted in a bearing seat 4 in the housing. An annular chamber 5, 6 is provided on both sides of the bearing seat 4 in the bearing housing, and each one of these chambers 5, 6 is sealed off against the exterior by a respective external seal 7. A threaded through bore 8 extends through the wall of the bearing housing and is positioned to open into one of the annular chambers 5. A grease nipple 9 is screwed into the threaded through bore 8 and a grease gun 10 can be coupled to the nipple 9 for introducing grease under pressure into the bearing housing for relubrication purposes. By providing an inner seal 11 in the annular chamber 5 where the grease thus can be introduced, it is possible to avoid having the grease introduced under pressure escape through the opening in the bearing housing at that chamber, with the grease being pressed through the bearing and into the opposite annular chamber 6 so that the grease is positively introduced into the bearing 2 where its lubricating and cooling properties are required.

However, this often used arrangement has some drawbacks. For example, a large quantity of surplus grease introduced as the grease, when being pressed in, will first fill up the major part of the annular chamber 5 before it will begin penetrating through the bearing, whereupon it will fill up at least a large portion of the opposite annular chamber 6 before the introduction of grease can be interrupted. This means that a large quantity of grease will be introduced into the bearing housing and will be trapped in positions in the bearing housing where it will have virtually no intended effect.

Bearing housings for two row rolling bearings also have in some arrangements a grease nipple bore positioned just in front of a channel leading from the exterior of the outer bearing ring and opening in the interior of the bearing in a position between the two rows of rolling bodies. An example is shown in British Patent Specification No. GB 1 385 834. This positioning of the grease supply bore will improve the possibility of introducing a comparatively small volume of grease into the bearing and bearing housing, while still obtaining sufficient and satisfactory lubrication of the bearing. The positioning of the grease nipple in such a position is however not suitable in all applications and therefore the use of such a design is often rejected.

European Patent Publication No. EP 0 290 091Al discloses a bearing housing having a grease nipple opening in a separate bent supply pipe positioned as a supply pipe held by a locking ring arranged adjacent the bearing and in contact with the non-rotating bearing ring thereof. This design is believed to lead the grease introduced via the grease nipple into the bearing in a manner not causing a significant gathering of inactive grease volumes in the annular chamber where the supply pipe is positioned. However, this design has a big drawback in that it requires two added elements, i.e. a supply pipe and a locking ring. It is evident that the assembly of such a bearing housing requires that it be made by a very careful and experienced person as the slightest incorrect positioning will result in more or less of the introduced grease not being lead by the supply pipe.

### SUMMARY OF THE INVENTION

According to one aspect of the invention, a grease lubricated bearing housing which possesses an interior has a housing wall arranged to form a bearing seat for an outer race ring of a bearing, and has on each axial side of the seat a space limited by an axially extending wall portion and a radial gable wall. The bearing housing has an opening for receiving a shaft supported in the bearing, with the wall of the bearing housing being provided with a through bore adapted to receive a grease nipple and opening to the interior of the bearing housing in at least one of the two spaces axially outside the bearing seat. The interior of the bearing housing wall is provided with a material conglomeration positioned in relative to the through bore opening into the interior of the bearing housing so that the material conglomeration urges grease introduced through the through bore to move primarily towards the bearing seat to inhibit grease from primarily filling out the space into which the through bore opens.

According to another aspect, a grease lubricated bearing housing comprises two housing parts which together form a housing interior provided with a bearing seat in which is seated an outer race ring of a bearing, with an annular chamber located on at least one axial side of the bearing seat and with the space being limited by an axially extending wall portion and a radial gable wall. The bearing housing also has an opening at least at one end for receiving a shaft passing at least partially thought the bearing housing. A first one of the bearing parts is provided with a bore extending from exterior of the bearing housing and opening into the space at a position axially outside the bearing seat, with the bore being adapted to receive a grease nipple to permit grease to be introduced into the housing interior. The first bearing part has an interior provided with a shield which directs grease introduced through the bore in a direction towards the bearing seat while also inhibiting grease from primarily filling out the space into which the bore opens.

The present invention provides an improved bearing housing which is not as susceptible to problems associated with earlier solutions regarding relubrication, with the relubrication being made possible in a relatively simple yet quite reliable manner.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a cross-sectional view of a known bearing housing permitting the introduction of lubricant.

FIG. 2 is a cross-section of a first embodiment of a bearing housing in accordance with the present invention.

FIG. 3 is perspective view obliquely from the inner side of the upper half of the bearing housing showing a modification of the upper bearing housing half shown in FIG. 2.

FIG. 4 is a perspective view of the inner side of the bearing housing half shown in FIG. 3, but viewed from a more central position.

FIG. 5 is another perspective view of the inner side of an upper bearing housing half according to an alternative embodiment of the present invention.

### DETAILED DESCRIPTION

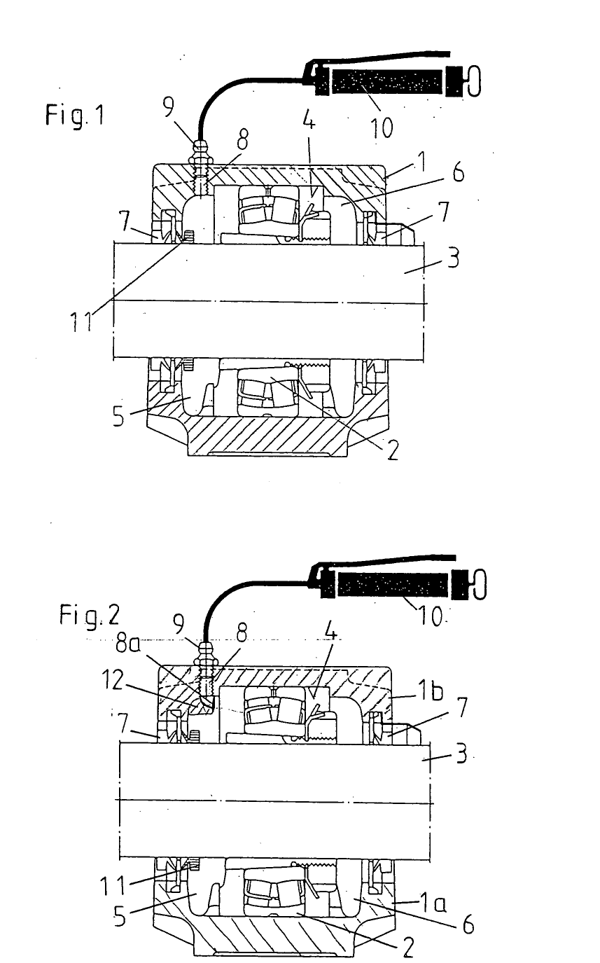

FIG. 2 illustrates one embodiment of the bearing housing according to the present invention in which components and features similar to those associated with the bearing arrangement depicted in FIG. 1 are identified by the same reference numerals. The bearing housing illustrated in FIG. 2 includes a lower bearing housing base (half) 1a and an upper bearing housing half 1b. A bearing 2 is mounted with its inner bearing ring positioned on a shaft 3 extending through the bearing housing and its outer bearing ring inserted in a bearing seat 4 in the housing. An annular chamber 5, 6 is provided on both sides of the bearing seat 4 in the bearing housing, with such annular chambers being limited by an axially extending wall portion and a radial gable wall. Each one of the annular chambers 5, 6 is sealed off from the exterior by way of an external seal 7. A threaded through bore 8 extending through the wall of the bearing housing is positioned to open into one of the annular chambers 5. A grease nipple 9 is screwed into the threaded through bore 8 and a grease gun 10 is adapted to be coupled to the nipple 9 for introducing grease under pressure into the bearing housing for relubrication purposes.

In addition, an annular seal 11 is provided in the annular chamber 5. By providing this inner seal 11 in the annular chamber 5 where the grease is introduced, the grease introduced under pressure will not escape through the opening in the bearing housing at that chamber.

One difference between the bearing housing arrangement shown in FIG. 1 and the bearing housing according to the present invention as shown in FIG. 2 relates to the upper bearing housing half 1b. The upper bearing housing half 1b is provided interiorly with a shield positioned relative to the bore 8 to cause the grease introduced through the through bore 8 to move or be directed primarily towards the bearing seat while also inhibiting grease from primarily filling out the space into which the through bore opens. In the illustrated embodiment here, the shield is a material conglomeration 12 which is integral and formed in one piece with the housing half. The integrated material conglomeration 12 is positioned in the area where the through bore 8 extends through the bearing housing wall. In the embodiment shown in FIG. 2, the through bore 8 also extends through the material conglomeration 12 and opens to a surface of the material conglomeration 12 facing the bearing 2 provided in the seat 4. In this manner, the grease introduced into the bearing housing under pressure by way of the grease gun 10 will be positively guided towards the bearing where the lubricating capacity of the grease is needed. At the same time, the grease will not have a tendency first to fill out the major part of the annular chamber 5.

The bearing housing, by virtue of it being formed by a casting operation, can be relatively easily provided with the material conglomeration 12 during production (i.e., during casting). The through bore 8 can then be produced by, for example, a drilling and tapping operation. The through bore 8 will thus penetrate the wall of the upper housing half 1b while also having a shield formed by the material in the integrated material conglomeration which causes the introduced grease to move more directly toward and inside the bearing 2 instead of first moving into the lower part of the chamber 5 and from there eventually into the chamber surrounded by the bearing seat 4.

As can be seen in this embodiment, the through bore 8 is made in such a manner that the orifice 8a of the through bore 8 opens in a direction facing towards the interior of the bearing 2, this being achieved by the bore being made in the material conglomeration 12 close to the inner edge thereof facing the bearing. The through bore 8 is thus not made radially right through the entire material conglomeration 12. Thus an orifice which curves toward the bearing is achieved.

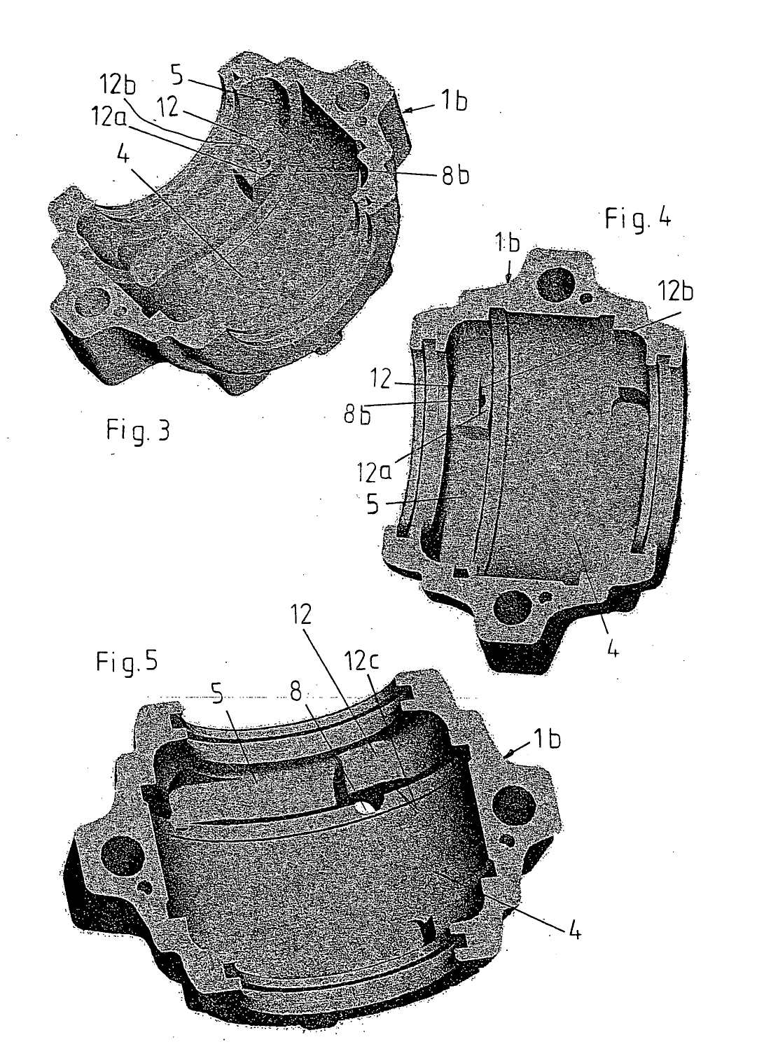

FIG. 3 is a perspective view seen obliquely from the inner side of the housing of an embodiment of an upper bearing housing half 1b which is somewhat modified compared to the embodiment shown in FIG. 2. This bearing housing half, which is shown without the bearing, the shaft and the seals, incorporates a bearing seat 4, and a side chamber 5 located axially beside the bearing seat 4. The housing wall of the chamber 5 at one radial position is provided with a shield in the form of a material conglomeration 12, made as an integral element formed in one piece with the bearing housing wall and projecting radially and axially towards the bearing seat 4. The material conglomeration 12 is made with a stepped portion at its interior end facing the bearing seat 4. This stepped portion incorporates an axially extending surface 12a and an adjoining substantially radially extending surface 12b. In this embodiment of the invention, the orifice 8b of the through bore 8 opens at this stepped portion of the material conglomeration 12. A combination of the axial and radial surfaces 12a, 12b of the stepped portion forms a shield or barrier urging grease introduced in the bearing housing via the bore 8 to move primarily towards the interior of the bearing seat compartment. In this way, the introduced grease does not at first fill out the chamber 5 in which the through hole 8 opens.

The bearing housing half 1b shown in FIG. 3 is also shown in perspective view in FIG. 4 in which the housing half 1b has been pivoted to a position where it is viewed almost straight from the inside. From this view, the stepped portion is illustrated as is the positioning of the surfaces 12a, 12b acting as a shield for grease introduced through the orifice 8b.

FIG. 5 illustrates a further embodiment of a bearing housing upper half 1b having a centrally located surface forming half a bearing seat 4 for a bearing. A semi-cylindrical chamber 5 is provided at one side of the bearing seat. A shield in the form of a an integral material conglomeration 12 or bulge having a radially extending surface 12c is formed integrally and in one piece with the housing half in the semi-cylindrical chamber 5. The through bore 8 for introducing grease is positioned immediately beside the material conglomeration 12, at the side of the material conglomeration 12 facing the bearing seat 4. With this arrangement, the bore 8 will have the radially extending surface 12c of the material conglomeration 12 directly adjacent itself, thereby urging or directing grease introduced under pressure through the through hole 8 in a way that inhibits the grease from moving in a direction away from the bearing seat 4.

The invention is not limited to the embodiments illustrated and described, but modifications and variants are possible within the scope of the accompanying drawings. Thus the bearing housing has been shown in the three different embodiments of the invention as a horizontally split, two-part bearing housing, supporting in a double-row spherical roller bearing a shaft extending through the housing. However, it is to be understood that the bearing housing can be designed in other manners and can support the shaft in other types of bearings than the type illustrated in FIG. 2. The bearing housing can also support a shaft which projects only from one side of the bearing housing, which in that case has an end cover inserted in the circular opening. In such an arrangement, the through-bore in the wall of the bearing housing is preferably situated at the side of the bearing housing opposed to that being prevented by such an end cover.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A grease lubricated bearing housing possessing an interior and having a housing wall arranged to form a bearing seat for an outer race ring of a bearing, and having on each axial side of the bearing seat a space limited by an axially extending wall portion and a radial gable wall, the bearing housing having an opening for receiving a shaft supported in the bearing, the wall of the bearing housing being provided with a through bore adapted to receive a grease nipple and opening to the interior of the bearing housing in at least one of the two spaces axially outside the bearing seat, an interior of the bearing housing wall being provided with a material conglomeration positioned in relative to the through bore opening into the interior of the bearing housing so that the material conglomeration urges grease introduced through the through bore to move primarily towards the bearing seat to inhibit grease from primarily filling out the space into which the through bore opens.

2. The bearing housing according to claim 1, wherein the through bore has an orifice extending through at least a part of the material conglomeration, said orifice being arranged to project in a direction towards the bearing seat.

3. The bearing housing according to claim 1, wherein the material conglomeration possesses a stepped portion comprised of an axially extending surface and an adjoining radially extending surface, the radially extending surface facing the bearing seat, and the through bore extending through the material conglomeration and opening in the axially extending surface, with the radially extending surface of the stepped portion in combination with the axially extending surface forming a shield urging grease introduced through the through bore to move primarily towards the bearing seat while also preventing grease from primarily filling out the space into which the through bore opens.

4. The bearing housing according to claim 1, wherein the through bore is positioned directly adjacent the material conglomeration in the bearing housing so that a radially extending surface of the material conglomeration forms a shield urging grease introduced through the through bore to move primarily towards the bearing seat while also preventing grease from primarily filling out the space into which the through bore opens.

5. The bearing housing according to claim 4, wherein the material conglomeration is an integrated portion of the wall of the bearing housing that is formed in one piece with the bearing housing.

6. The bearing housing according to claim 4, wherein the material conglomeration is a bulge-formed integrated portion of the wall of the bearing housing.

7. The bearing housing according to claim 3, wherein the material conglomeration is an integrated portion of the wall of the bearing housing that is formed in one piece with the bearing housing.

8. The bearing housing according to claim 3, wherein the material conglomeration is a bulge-formed integrated portion of the wall of the bearing housing.

9. The bearing housing according to claim 2, wherein the material conglomeration is an integrated portion of the wall of the bearing housing that is formed in one piece with the bearing housing.

10. The bearing housing according to claim 2, wherein the material conglomeration is a bulge-formed integrated portion of the wall of the bearing housing.

11. The bearing housing according to claim 1, wherein the material conglomeration is an integrated portion of the wall of the bearing housing that is formed in one piece with the bearing housing.

12. The bearing housing according to claim 1, wherein the material conglomeration is a bulge-formed integrated portion of the wall of the bearing housing.

13. A grease lubricated bearing housing comprising two housing parts which together form a housing interior provided with a bearing seat in which is seated an outer race ring of a bearing, with an annular chamber located on at least one axial side of the bearing seat, the space being limited by an axially extending wall portion and a radial gable wall, the bearing housing having an opening at least at one end for receiving a shaft passing at least partially thought the bearing housing, a first one of the bearing parts being provided with a bore extending from exterior of the bearing housing and opening into the space at a position axially outside the bearing seat, the bore being adapted to receive a grease nipple to permit grease to be introduced into the housing interior, the first bearing part having an interior provided with a shield which directs grease introduced through the bore in a direction towards the bearing seat while also inhibiting grease from primarily filling out the space into which the bore opens.

14. The bearing housing according to claim 13 wherein the shield is integrally formed in one piece with the first bearing part, and the bore extending through at least a part of the shield.

15. The bearing housing according to claim 13, wherein the shield is a material conglomeration formed integrally with the first bearing part and extending inwardly from the interior of the first bearing part, the bore having an orifice extending through at least a part of the material conglomeration and arranged to project in a direction towards the bearing seat.

16. The bearing housing according to claim 13 wherein the shield possesses a stepped configuration comprised of an axially extending surface and an adjoining radially extending surface, the radially extending surface facing the bearing seat, and the bore extending through the shield and opening in the axially extending surface, the radially extending surface in combination with the axially extending surface forming the shield.

17. The bearing housing according to claim 13 wherein the shield comprises a radially extending surface and the bore is positioned directly adjacent the radially extending surface.

18. The bearing housing according to claim 13, wherein the shield is an integrated portion of the first housing part that is formed in one piece with the first housing part.

19. The bearing housing according to claim 13, wherein the shield is a bulge-formed integrated portion of the first housing part.
